(19) United States
(12) Patent Application Publication
(10) Pub. No.: US 2012/0186520 A1
(43) Pub. Date: Jul. 26, 2012

(54) PORTABLE CONTAINMENT DEVICE

(75) Inventor: Andrew Hill, Glenella (AU)

(73) Assignee: Andrew Hill, Glenella (AU)

(21) Appl. No.: 13/388,965

(22) PCT Filed: Aug. 3, 2010
(86) PCT No.: PCT/AU2010/000980

§ 371 Date: Apr. 12, 2012

(30) Foreign Application Priority Data
Aug. 4, 2009 (AU) 2009903636

(51) Int. Cl. B05B 1/00; B24C 3/06; B24C 9/00

(52) U.S. Cl. 118/713; 451/451; 451/456

(57) ABSTRACT

The invention provides a housing defining a chamber, within which chamber an operator can perform a procedure on an object, the housing comprising a forward edge portion which in use, is located adjacent the object; viewing means for allowing the operator to see into the chamber; at least one input port through which a tool can access the chamber; and at least one evacuation port through which any waste material produced is removed from within the chamber; such that the procedure is performed in a contained environment.

### TECHNICAL FIELD

The invention described herein relates generally to a device for the containment of debris such as rust and dust, and also for the containment of fumes and welding flash. The invention also provides a safe work environment for operators of the device, which is particularly important in situations where access is difficult, for example, when abseiling or diving is required for access. In particular, the invention is directed to a blast box for containing debris when blasting surfaces for the purposes of maintenance and cleaning, although the scope of the invention is not necessarily limited thereto.

### BACKGROUND ART

A large variety of sand blasting cabinets are known. The cabinets generally include some form of hood or chamber within which the blasting takes place, a sand blasting gun or nozzle and means to contain the spent sand and any debris resulting from the blasting.

An early version of a sand blasting hood is disclosed in U.S. Pat. No. 1,773,375. This hood is intended to be positioned in close proximity to stone monuments such as cemetery monuments to generally seal the area to be sand blasted. The hood has a sight screen enabling the operator to view the work area, whilst confining debris and sand within the hood, and a funnel-like portion to direct spent sand into a receptacle.

A prior art blasting cabinet for sand blasting hand-held items is described in U.S. Pat. No. 3,599,375. The cabinet is provided with wheels for mobility, a sand blasting gun and an optional vacuum system to remove airborne dust particles. The cabinet additionally has two openings, one for the operator's hand containing the article to be sand blasted, and the other for the nozzle of the sand blasting gun.

A further development in blasting cabinets is disclosed in U.S. Pat. No. 5,775,979. This document discloses a system which comprises a movable and adjustable boom and an operator containment facility mounted on the end of the boom, intended for using in blasting a surface such as a ship hull. The containment facility has a rubber seal that is placed against the working surface and seals against the surface by virtue of a waste collection system which creates a negative pressure in the containment facility.

The prior art sand blasting devices are therefore often designed having regard to a specific application, and as such lack flexibility with respect to their use.

In addition, during blasting a great deal of dust and debris is generated, as a result of the combination of abrasive material used to effect the blasting and the material removed from surface being blasted. Although the majority of prior art blasting devices provide for the containment of the dust and debris, the containment is not fully effective, in that a portion of the dust and debris escapes into the atmosphere.

Previously, failure to completely contain dust and debris which has been deemed non-hazardous, has been accepted as inevitable. Where the dust and debris is hazardous, such as debris which includes lead-based paint, failure to completely contain the debris risks both the operator of the blasting device and the environment. Although non-containment of hazardous debris is not acceptable, in practice complete containment is not readily achievable. In addition, increased awareness of the effects of pollution on the environment, has led in many countries to the enactment of legislation which requires containment of all debris.

U.S. Pat. No. 5,367,841 describes a containment structure for abrasive blasting equipment intended for use on large structures such as storage tanks and bridges. The structure provides for efficient containment of hazardous debris. However, although the containment structure is described as being portable, it comprises a portable room which is suspended by a system of cables and rollers and therefore has a great deal of associated infrastructure.

Therefore, there would be an advantage if it were possible to provide a portable device for the containment of debris when sandblasting surfaces for the purposes of maintenance and cleaning, which may overcome at least some of the above-mentioned disadvantages or provide a useful or commercial choice.

### SUMMARY OF THE INVENTION

In a first embodiment, the invention provides a housing defining a chamber, within which chamber an operator can perform a procedure on an object, the housing comprising:
a) a forward edge portion which in use, is located adjacent the object;
b) viewing means for allowing the operator to see into the chamber;
c) at least one input port through which a tool can access the chamber; and
d) at least one evacuation port through which any waste material produced is removed from within the chamber;
   such that the procedure is performed in a contained environment.

In a second embodiment, the invention provides a housing defining a chamber, within which chamber an operator can perform at least one procedure on an object using at least one tool located within the chamber, the housing comprising:
a) a forward edge portion which in use, is located adjacent the object;
b) viewing means for allowing the operator to see into the chamber;
c) at least one input port through which an umbilical can enter the chamber and communicate with the at least one tool;
d) at least one access port through which the operator can manipulate the at least one tool; and
e) at least one evacuation port through which any waste material produced is removed from within the chamber;
   such that the at least one procedure is performed in a contained environment.

Procedures which are required to be performed within a contained environment include blasting. The term “blasting” is used to refer to any type of abrasive blast cleaning and is not to be limited to blasting cleaning using sand as the abrasive agent. Blasting is required to be performed within a contained environment in order to minimize the release of pollutants into the atmosphere.

The term “umbilical” is used to refer to any type of cable or conduit which is required for operation of a tool within the chamber. The term “umbilical” can therefore include a cable which supplies power to a tool within the chamber, a cable which supplies air or other gases to the chamber or a cable which supplies both power and gas to the chamber.

The invention can be used for blasting to remove surface rust or corrosion from structures such as pylons, buildings and ship hulls. In further embodiments, the invention can be used for cleaning objects or structures, such as removing scale, dirt or grease. Alternatively, the invention can be used to remove an unwanted finish from an object, such as removing paint or lacquer.

Where the invention is required to be used in combination with abseiling, for example, when undertaking work on pylons, use of the invention advantageously provides a lateral anchor point. This lateral anchor point assists in minimizing swing of the abseiler and is in addition to the anchor point at the top of the climbing ropes. In addition, the lateral anchor point advantageously provides an anchor point which is non-destructive to the object to which it is attached.

The invention can also be used to apply a finish to an object, such as paint or an anti-corrosion agent. Application of these products may release fumes and/or contaminants and therefore should be undertaken in a contained environment.

Other procedures which are advantageously performed in a contained environment include treatment of contaminated material, all types of welding, plasma etching and bomb disposal.

Aquatic applications of the invention include cleaning up oil spills or ocean debris, dredging to maintain shipping channels or other waterway access, and as a repair port for attending to structural damage in a ship's hull.

A particular aquatic application of the invention is underwater welding. Specifically use of the invention enables dry welding underwater whilst providing a stable anchor point for the diver operator. In addition, use of the invention allows for a protective coating such as paint to be applied to an underwater weld. Following dry welding, due to the contained, dry environment provided by the invention, a coating which would normally only be used above the water line can be applied to the freshly welded surface, even though it is under the water line.

The invention is also suited to a number of medical applications, including undertaking surgical procedures in non-sterile environments.

With regard to the embodiments as defined above, the chamber can be of any suitable shape and size, dependent on the procedure to be performed within the chamber as a contained environment. The invention can thus be utilized for a wide variety of applications where an article or portion of an article is required to be in an enclosed environment. A particular advantage of the invention is its portability, which enables it to be utilized in a wide variety of applications and environments.

The housing defining the chamber can therefore be of any suitable shape and size, dependent on the procedure to be performed within the chamber. Due to the broad range of applications for the invention, the housing can be subjected to a number of differing environments, including normal, high and low atmospheric pressure and aqueous environments, such as underwater. Therefore, the housing can be manufactured from a material that is suited to the environment in which it will be utilized.

For underwater applications, the housing is therefore preferably manufactured from a material that is sufficiently robust to survive direct immersion in water for prolonged periods of time. For noisy applications, such as blasting and bomb disposal, the housing can be provided with a noise-absorbing lining such that noise pollution is minimised.

The forward edge portion can comprise any suitable means for locating the housing adjacent an object on which a procedure is to be performed. In one embodiment, the forward edge portion can comprise seal means which engages the object to seal the housing relative to the object. The seal means can therefore comprise a resilient member which provides for an air- or water-tight seal between the housing and the object, irrespective of the shape of the object. In an alternative embodiment, the seal means can comprise a non-resilient member which provides for an air- or water-tight seal between the housing and object.

In a further embodiment, the forward edge portion can comprise magnetic or electromagnetic attachment means for engaging a steel object to locate and secure the housing. The magnetic or electromagnetic attachment means can provide for direct engagement of the housing with an object or can provide for positioning of the housing in proximity to the object. Positioning of the housing in proximity to the object allows for a procedure to be performed on the object, in a contained environment, without the forward edge portion physically in contact with the object, such that the housing is “levitated” with respect to the object.

Positioning of the housing in a “levitated” or closely spaced but separated manner is particularly advantageous where physical contact of the forward edge portion with the object would interfere with the procedure being performed. An example of such interference would be where a large portion of an object is to be painted, but the housing only encloses a portion of the object. Direct contact of the forward edge portion with the freshly painted object during movement of the housing to a further portion of the object to be painted would disturb the finish of the freshly painted portion.

A further example of a situation where positioning of the housing in a “levitated” or closely spaced but separated manner would be particularly advantageous, is during electromagnetic spraying of paint, including spraying of plasma-infused paint.

The “levitated” configuration should also be provided such that escape of material from within the housing or ingress of material about the forward edge is restricted or prevented entirely. One method for doing so is the provision of a high pressure air curtain or the like to prevent escape or ingress of material.

Positioning of the housing either directly on the object or in proximity to the object (as in a levitated manner) can be controlled by the pressure within the chamber. Controlled positive pressure will allow for the housing to be maintained in proximity to the object, whilst controlled negative pressure will allow for the housing to be maintained in a position directly engaged with the object.

The pressure within the chamber can be controlled by a combination of vacuum means and air intake means. The vacuum means can comprise one or more vacuum ports on the housing which are in air communication with the chamber. The vacuum means can additionally comprise features such as a vacuum relief valve and/or a vacuum gauge. The number of vacuum ports, in combination with the power of the vacuum applied therethrough, can be varied to assist with controlling the pressure within the chamber. For example, the use of multiple vacuum ports on the housing increases the surface area of vacuum when compared to a housing having a single vacuum port. In addition, multiple vacuum ports can improve visibility within the chamber.

The air intake means can comprise one or more ports on the housing in air communication with the chamber, through which air can be introduced to the chamber. The air intake means can additionally comprise a pressure gauge and/or a moisture filter. In a preferred embodiment, the air intake means comprises a port on the housing connected to a source of air. A series of air outlets within the chamber provides for the air to be dispersed into the chamber. In a particularly preferred embodiment, the air intake means comprises a series of air outlets which are positioned within the chamber in proximity to the viewing means. Positioning the air outlets in proximity to the viewing means can assist with visibility within the chamber.

Referring to the embodiments above, the viewing means can be any means which provides for the operator to be apprised of conditions within the chamber. The viewing means can therefore be a viewing window allowing for direct viewing of the interior of the chamber. The viewing window can be made from any suitable material, dependent on the environment in which the housing is to be used and the operation to be performed within the chamber. The viewing window can therefore be made from materials including glass or Perspex and may further include shading, ultraviolet (UV) and/or infrared (IR) filters.

The housing can additionally be provided with lighting means to assist with visibility in the chamber. The lighting means can be positioned at one or more suitable positions within the chamber and can be any suitable form of lighting. In a particularly preferred embodiment the lighting means are light-emitting diodes (LEDs) positioned on both sides of the viewing window.

The viewing window can further comprise an electronic display, such as a liquid crystal display (LCD) which provides the operator with information on conditions within the chamber.

In alternative embodiments, the viewing window can consist of an LCD, such that the operator can monitor conditions within the chamber, without direct vision of the chamber. This is particularly advantageous under conditions of low light, where the procedure to be performed is required to take place in the absence of light or where conditions within the chamber during the operation are such that vision is impaired.

In further alternative embodiments, imaging technology such as thermal imaging or radio imaging can be used to monitor conditions and the progress of operations within the chamber, thereby avoiding the need for a clear viewing window which is potentially subject to damage from debris within the chamber.

With regard to the embodiments as defined above, the at least one input port can be at any suitable position on the housing. In addition, the at least one input port can be of any structure or form suited to the procedure to be performed, and therefore the tool required. Therefore, in one embodiment, where the chamber is to be used for sand blasting a pylon to remove rust, the at least one input port can be a port which provides for the introduction of a blasting gun into the chamber. In this particular embodiment, the at least one input port can provide for the introduction of just the nozzle or a forward portion of the blasting gun into the chamber. Alternatively, the at least one input port can provide for the introduction of the entire blasting gun into the chamber and additionally allow for the operators hand to operate the blasting gun in the manner of a glovebox.

Dependent on the procedure to be performed in the chamber, it is not necessary for the at least one input port to provide for a tool to be inserted into the chamber. In some embodiments, the at least one input port can provide for a tool to have an effect on the interior of the chamber without actually being in or within the chamber. For example, if the chamber were to be used for cleaning an oil spill on a body of water and the tool was therefore a vacuum line.

Due to the broad range of applications for the invention, the features of the at least one input port will depend on the tool required to perform the desired procedure. The tool can include such tools as a blasting gun suitable for wet or dry blasting, a vacuum line, welding tools, a spray painting gun, etching tools, medical tools or a probe. In an alternative embodiment of the invention, all tools required for a particular task can be present within the chamber or have an effect on the interior of the chamber. Such an embodiment allows for a complete series of procedures to be performed without breaking or breaching the contained atmosphere of the chamber. A specific embodiment of the invention would therefore provide for blasting, welding and painting (for example, of a pylon) to be undertaken using a single embodiment without the need to re-tool the housing after each procedure.

Referring to the embodiments above, the at least one evacuation port can be at any suitable position on the housing. In addition, the at least one evacuation port can be of any structure or form suited to the procedure to be performed and therefore the waste material to be removed from the chamber. The at least one evacuation port can therefore be a vacuum line for the removal of blasting waste, fumes and/or dust.

The at least one evacuation port can further comprise a separation means such as at least one filter and/or scrubber system and/or cyclonic separation means. The filter can any form or type of filter or filtration system known in the art. The filter could therefore be a water filtration system, air filtration system or a cyclonic filter/cyclonic separation system.

The embodiments as defined above can be used in association with locating means. The locating means can be any suitable means which allows for the operator to access and position the housing adjacent an object on which a procedure is to be performed. In a preferred embodiment, the locating means can comprise an aerial work platform providing temporary, flexible access.

In an alternative embodiment, the locating means can comprise a work platform for using during welding either under or above water, such as may be required when welding pipes or pylons. The locating means thereby provides a stable, temporary support for the operator.

The locating means can therefore comprise a platform, container or enclosure, wherein the platform, container or enclosure is adapted to attach to a structure. For example, when using the invention to maintain pylons, including for blasting and re-surfacing the pylons, the locating means can comprise a platform adapted to attach to a pylon, so that the operator can readily position the housing adjacent the desired region of the pylon to be blasted and re-surfaced.

The locating means can further comprise positioning means so that the locating means can access any region of an object, irrespective of the surface and/or angle of the object. The locating means therefore has positional translation means and positional rotational means. In a particular preferred embodiment, the positioning means comprises hydraulic means.

In addition to enabling the locating means to access any region of an object, the positioning means can also assist with providing support when joining pipes, such as when laying a pipeline, or when joining columns to provide pylons of increased length. The positioning means can therefore comprise at least one bracket which can be positioned about a join region between two sections of pipe or column. Positioning brackets about a join provides stability for the join prior to securing the join by more permanent means, such as welding. In particular, the brackets can be adapted to allow for spot welding of the join sufficient to hold the join once the brackets are moved from their stabilizing position.

In order that the invention may be more readily understood and put into practice, one or more preferred embodiments thereof will now be described, by way of example only, with reference to the accompanying drawings.

### BRIEF DESCRIPTION OF THE DRAWINGS

FIG. 1 is a side plan view of a portable containment device according to an embodiment of the invention.

FIG. 2 is a top plan view of the portable containment device of FIG. 1.

FIG. 3 is a side view of a portable containment device according to an embodiment of the invention.

FIG. 4 is a rear view of the portable containment device of FIG. 3.

FIG. 5 is a bottom view of the portable containment device of FIG. 3.

FIG. 6 is a top view of the portable containment device of FIG. 3.

FIG. 7 is a view of a portable containment device according to an embodiment of the invention.

FIG. 8 is a view of a portable containment device according to a further embodiment of the invention.

FIG. 9 is a view of a portable containment device according to a still further embodiment of the invention.

FIG. 10 is a view into the chamber of a portable containment device according to an embodiment of the invention.

FIG. 11 is a side view of a locating means as used in association with an embodiment of the invention.

FIG. 12 is a side view of the locating means of FIG. 11 in a semi-extended conformation.

FIG. 13 is a side view of the locating means of FIG. 11 in a fully-extended conformation.

### DETAILED DESCRIPTION OF PREFERRED EMBODIMENTS

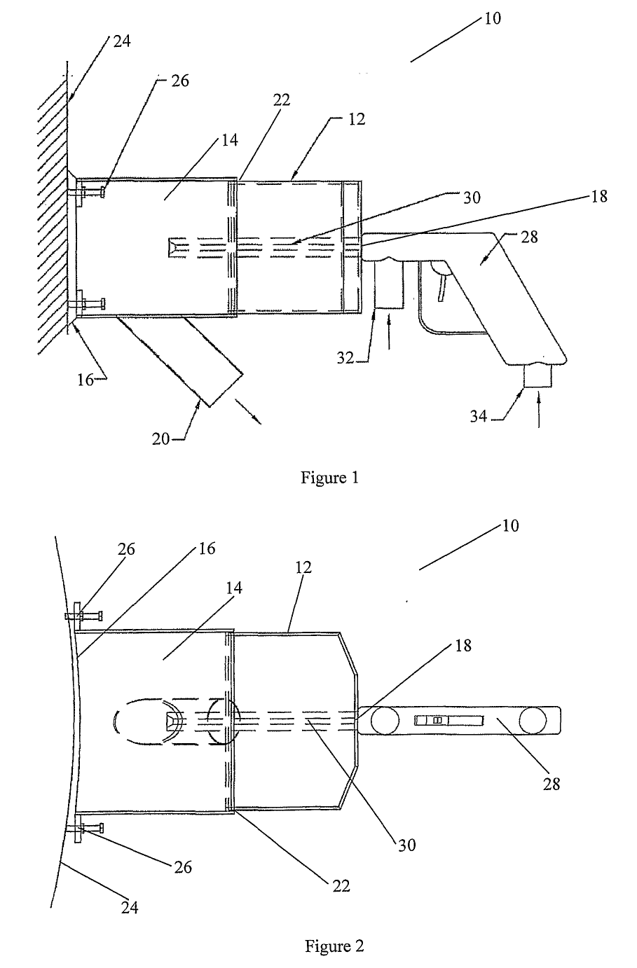

Referring firstly to FIG. 1, a side plan view of a portable containment device 10 according to an embodiment of the invention is shown. The device 10 comprises a housing 12 defining a chamber 14, a forward edge portion 16, an input port 18, and an evacuation port 20. In this embodiment, the housing 12 comprises telescopic means 22 such that the size of the chamber 14 can be varied.

The device 10 is located adjacent an object 24 via the forward edge portion 16. Guide means 26 assist with positioning the device 10 on the object 24. The chamber 14 is accessed by an application device 28. In this embodiment, the application device 28 could be any type of application device, including a blasting gun or a spray paint nozzle.

The application device 28 comprises an application nozzle 30 and intake means 32 for supplying the product, such as blasting material or paint, which is to be applied to the object 24 via the application nozzle 30. The application device 28 further comprises air intake means 34 for assisting with application of the product to the object 24.

Any waste materials produced within the chamber 14 are removed from the chamber 14 via the evacuation port 20.

A top plan view of the portable containment device of FIG. 1 is shown in FIG. 2, with features corresponding to those of FIG. 1 numbered similarly.

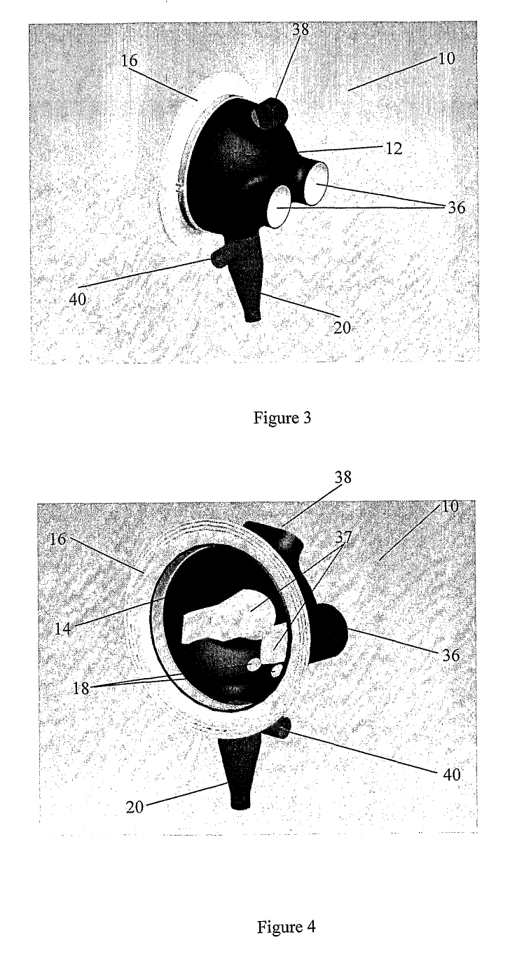

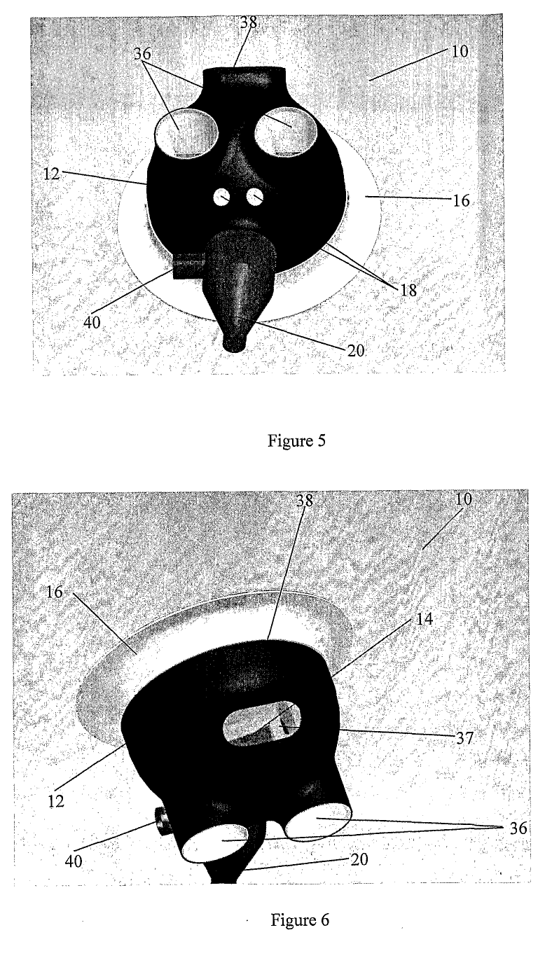

Differing views of a portable containment device 10 according to an embodiment of the invention are shown in FIGS. 3 to 6, with corresponding features numbered similarly. The device 10 comprises a housing 12 defining a chamber 14, a forward edge portion 16, access ports 36 and viewing means 38. The access ports 36 are fitted with gloves 37 to assist the operator in manipulating a tool within the chamber 14. Any waste materials produced within the chamber are removed from via the evacuation port 20.

The device 10 further comprises a vacuum port 40 which can be connected to a vacuum line to control the pressure within the chamber. The device 10 further comprises input ports 18.

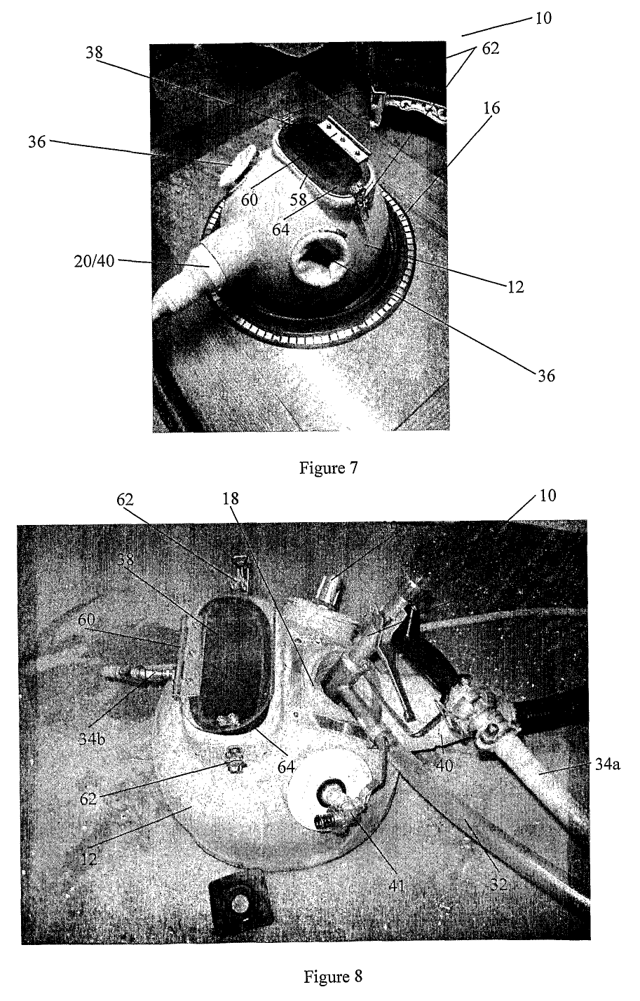

FIG. 7 is a view of a portable containment device 10 according to an embodiment of the invention. The device 10 comprises a housing 12 defining a chamber, a forward edge portion 16, access ports 36 and viewing means 38. The access ports 36 enable the operator to manipulate a tool within the chamber. Any waste materials produced within the chamber are removed from via the evacuation/vacuum port 20/40.

The viewing means 38 comprises a transparent window 58 which is connected to the housing 12 via a hinge 60. Clips 62 and a seal 64 provide for closing of the transparent window 58.

FIG. 8 is a view of a portable containment device 10 according to a further embodiment of the invention. The device 10 comprises a housing 12 defining a chamber, an input port 18, viewing means 38, lighting means 39, vacuum intake relief valve 41, positive air intake means 34b and a vacuum port 40. The chamber is accessed by an application device 28. In this embodiment, the application device 28 is a blasting gun.

The application device 28 comprises intake means 32 for supplying the blasting material. The application device 28 further comprises air intake means 34a for assisting with application of the blasting material. The lighting means 39 provide light within the chamber to assist with visibility. Any waste materials produced within the chamber are removed from the chamber via the vacuum port 40.

The positive air intake 34b provides for the introduction of air into the chamber and in combination with the vacuum applied via vacuum port 40 assists in controlling the pressure within the chamber. The vacuum intake relief valve 41 can also be used to assist in controlling the pressure within the chamber.

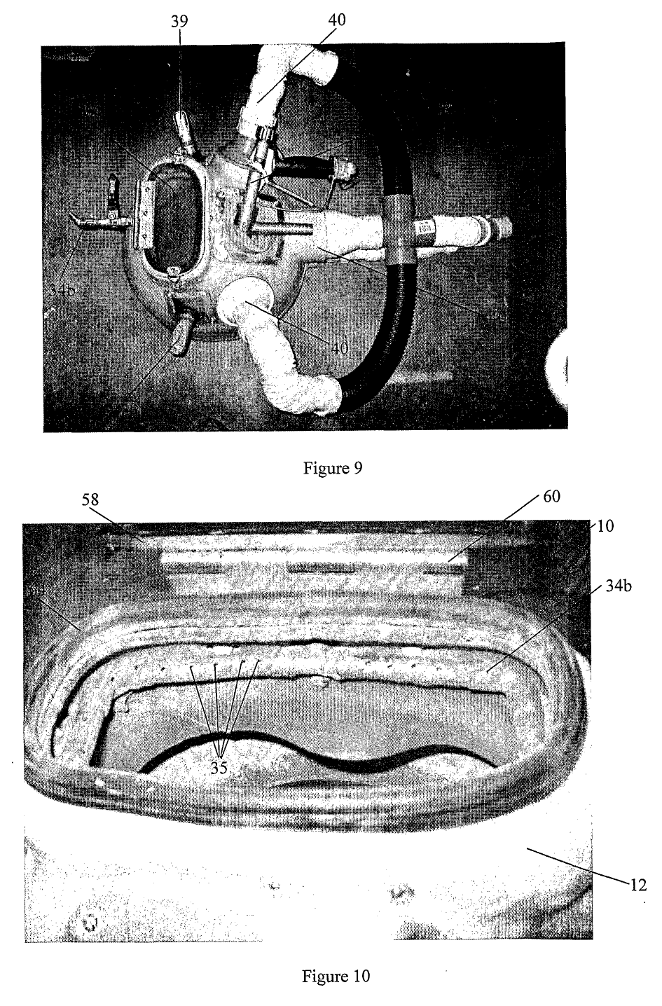

A still further embodiment of a portable containment device 10 according to the invention is shown in FIG. 9. Features corresponding to those of FIG. 8 are numbered similarly. The device of FIG. 9 has additional vacuum ports 40 and lighting means 39. The lighting means 39 provide light within the chamber to assist with visibility.

FIG. 10 is a view into the chamber of a portable containment device 10 showing a close-up of the interior in proximity to the viewing means. In this embodiment, air intake means 34b which provide for the introduction of air into the chamber 14 are shown. The air intake means 34b further comprises a series of air outlets 35. The air outlets 35 are positioned around the perimeter of the viewing means 38 to assist with visibility when an operator is viewing a procedure within the chamber.

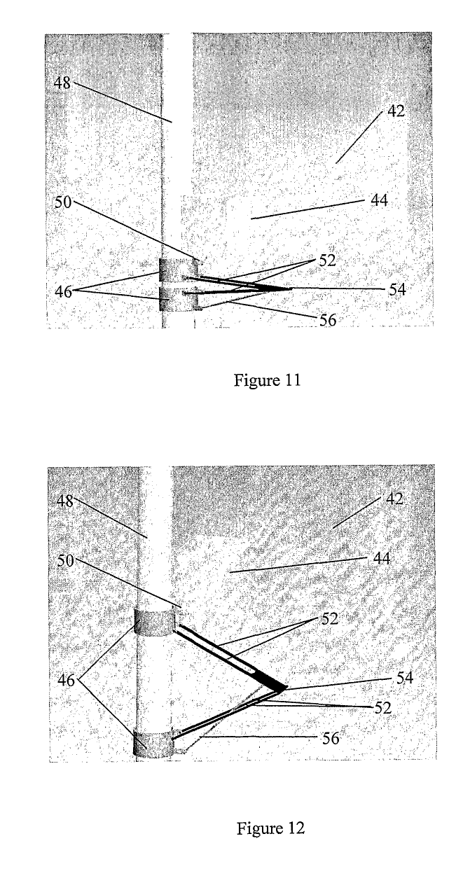

A side view of an embodiment of locating means 42 which can be used in association with a portable containment device of the invention is shown in FIG. 11. The locating means 42 comprises a container 44 capable of accommodating at least one operator and from where the operator can position a portable containment device according to the invention adjacent to an object.

The locating means 42 further comprises brackets 46 for attaching the container 44 to a pylon 48. The container 44 is connected to a bracket 46 via connection means 50 which allow the container 44 to rotate through any desired angle to assist with access to all areas of the pylon 48. The brackets 46 are connected to each other via arms 52, connected by hinge means 54, which combined with hydraulic rod 56 assist in the movement of the locating means 42 along the pylon 48.

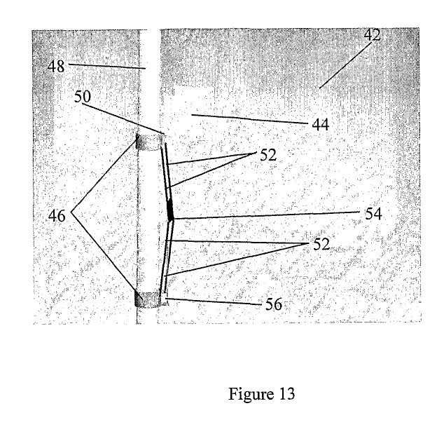

Movement of the locating means 42 along the pylon 48 is shown in FIGS. 12 and 13 in which features corresponding to those of FIG. 11 are numbered similarly.

FIG. 12 is a side view of the locating means 42 of FIG. 11 in a semi-extended conformation. Action of the hydraulic rod 56 has enabled the arms 52 to extend about the hinge means 54, such that the container 44 is moved to a higher position on the pylon 48. Further movement of the container 44 along the pylon 48 as the arms 52 extend further about the hinge means 54 is shown in FIG. 13.

The following sequence of events enables the locating means 42 of FIGS. 11 to 13 to “climb” the pylon 48:
(i) locking of upper bracket 46;
(ii) release lower bracket 46;
(iii) lower bracket 46 is positioned closer to upper bracket 46;
(iv) locking of lower bracket 46 at its new, higher position;
(v) release upper bracket 46;
(vi) upper bracket is positioned further from lower bracket 46; and
(vii) locking of upper bracket 46 at its new, higher position, such that the cycle of “climbing” continues from step (ii), above.

The brackets 46, in addition to assisting with enabling the locating means 42 to climb a pylon 48, can provide support during joining pipes, such as when laying a pipeline, or when joining columns to provide pylons of increased length. Specifically, a bracket 46 of the locating means 42 can be positioned about a join region between two sections of pipe or column. Positioning a bracket 46 in this way provides stability for the join prior to securing the join by more permanent means, such as welding. In particular, the bracket 46 can be adapted to allow for spot welding of the join sufficient to hold the join once the bracket 46 is moved from its stabilizing position.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

1. A housing defining a chamber, within which chamber an operator can perform a procedure on an object, the housing comprising:
a) a forward edge portion which in use, is located adjacent the object;
b) viewing means for allowing the operator to see into the chamber;
c) at least one input port through which a tool can access the chamber; and
d) at least one evacuation port through which any waste material produced is removed from within the chamber;
such that the procedure is performed into a contained environment.

2. The housing of claim 1, wherein the forward edge portion comprises seal means which engage with the object to seal the housing relative to the object.

3. The housing of claim 1, wherein the forward edge portion comprises magnetic or electromagnetic attachment means for locating the housing in proximity to a metal object.

4. The housing of claim 1, wherein the at least one evacuation portion comprises one or more vacuum ports.

5. The housing of claim 4, wherein the one or more vacuum ports further comprise a vacuum gauge and/or a vacuum relief valve.

6. The housing of claim 5, wherein one or more of the vacuum ports is connected to a filter.

7. The housing of claim 1, further comprising at least one air intake means for controlling the pressure within the housing.

8. The housing of claim 1 comprising one input port.

9. The housing of claim 8, wherein the tool is a blasting gun or a spray paint nozzle.

10. A housing defining a chamber, within which chamber an operator can perform at least one procedure on an object using at least one tool located within the chamber, the housing comprising:
a) a forward edge portion which in use, is located adjacent the object;
b) viewing means for allowing the operator to see into the chamber;
c) at least one input port through which an umbilical can enter the chamber and communicate with the at least one tool;
d) at least one access port through which the operator can manipulate the at least one tool; and
e) at least one evacuation port through which any waste material produced is removed from within the chamber;
such that the at least one procedure is performed in a contained environment.

11. The housing of claim 10, wherein the forward edge portion comprises seal means which engage with the object to seal the housing relative to the object.

12. The housing of claim 10, wherein the forward edge portion comprises magnetic or electromagnetic attachment means for locating the housing in proximity to a metal object.

13. The housing of claim 10, wherein the at least one evacuation port comprises one or more vacuum ports.

14. The housing of claim 13, wherein the one or more vacuum ports further comprise a vacuum gauge and/or a vacuum relief valve.

15. The housing of claim 14, wherein one or more of the vacuum ports is connected to a filter.

16. The housing of claim 10, further comprising at least one air intake means for controlling the pressure within the housing.

17. The housing of claim 16, wherein the tool is a blasting gun or a spray nozzle and the umbilical is a power and gas cable to enable operation of the blasting gun or spray nozzle.

18. The housing of claim 17 comprising two input ports.

19. The housing of claim 18, wherein the input ports are fitted with gloves.
